(19) United States
(12) Patent Application Publication
(10) Pub. No.: US 2025/0380091 A1
(43) Pub. Date: Dec. 11, 2025

(54) MEMS Microphone

(71) Applicant: AAC ACOUSTIC TECHNOLOGIES (SHENZHEN) CO., LTD., Shenzhen (CN)

(72) Inventors: Zhuanzhuan Zhao, Shenzhen (CN); Bo Li, Shenzhen (CN); Kaijie Wang, Shenzhen (CN); Rui Zhang, Shenzhen (CN); Yu Chen, Singapore (SG)

(21) Appl. No.: 19/001,523

(22) Filed: Dec. 25, 2024

Related U.S. Application Data
(63) Continuation of application No. PCT/CN2024/097641, filed on Jun. 6, 2024.

(51) Int. Cl. H04R 19/04; H04R 7/04

(52) U.S. Cl. CPC H04R 19/04; H04R 7/04; H04R 2201/003

(57) ABSTRACT

A MEMS microphone is disclosed. The MEMS microphone includes a substrate with a cavity, a backplate disposed above the substrate, a diaphragm disposed between the backplate and the substrate, and a limiting structure disposed in the cavity for limiting a maximum displacement of the diaphragm away from the backplate that is not less than a normal working displacement of the diaphragm away from the backplate. The MEMS microphone improves the reliability.

### FIELD OF THE PRESENT DISCLOSURE

The present disclosure relates to microphones, and in particular, to a MEMS microphone.

### DESCRIPTION OF THE RELATED ART

A traditional MEMS microphone includes a substrate with a cavity, a backplate disposed above the substrate, and a diaphragm disposed between the backplate and the substrate. The cavity has a shape similar to that of the diaphragm. The diaphragm moves towards or away from the backplate under an air flow impact.

However, since the diaphragm moves away from the backplate without a limitation, when the air flow impact is large enough, a displacement of the diaphragm away from the backplate exceeds the ultimate displacement that a material of the diaphragm can withstand, the diaphragm is damaged. As a result, the reliability of the traditional MEMS microphone is not good.

Thus, it is necessary to provide a novel MEMS microphone to solve the problems.

### SUMMARY

An objective of the present disclosure is to overcome the above problems and provide a MEMS microphone which improves the reliability.

In order to achieve the objective mentioned above, the present disclosure discloses a MEMS microphone including a substrate with a cavity, a backplate disposed above the substrate, a diaphragm disposed between the backplate and the substrate, and a limiting structure disposed in the cavity for limiting a maximum displacement of the diaphragm away from the backplate that is not less than a normal working displacement of the diaphragm away from the backplate.

As an improvement, the substrate includes a top wall, a bottom wall opposite to the top wall, and an enclosure wall connecting the top wall and the bottom wall and enclosing the cavity. The limiting structure is formed by a single connecting wall connected to the enclosure wall.

As an improvement, the substrate includes a top wall, a bottom wall opposite to the top wall, and an enclosure wall connecting the top wall and the bottom wall and enclosing the cavity. The limiting structure is formed by at least two connecting walls connected to the enclosure wall and intersecting each other.

As an improvement, the at least two connecting walls intersect at one place and form equal intersection intervals.

As an improvement, the substrate includes a top wall, a bottom wall opposite to the top wall, and an enclosure wall connecting the top wall and the bottom wall and enclosing the cavity. The limiting structure is connected to the enclosure wall. The top wall is arranged flush with a top of the limiting structure. The bottom wall is arranged flush with a bottom of the limiting structure.

As an improvement, the substrate includes a top wall, a bottom wall opposite to the top wall, and an enclosure wall connecting the top wall and the bottom wall and enclosing the cavity. The limiting structure is connected to the enclosure wall. The top wall is arranged flush with a top of the limiting structure. A bottom of the limiting structure is closer to the diaphragm relative to the bottom wall.

As an improvement, the substrate includes a top wall, a bottom wall opposite to the top wall, and an enclosure wall connecting the top wall and the bottom wall and enclosing the cavity. The limiting structure is connected to the enclosure wall. The bottom wall is arranged flush with a bottom of the limiting structure. The top wall is closer to the diaphragm relative to a top of the limiting structure.

As an improvement, the substrate includes a top wall, a bottom wall opposite to the top wall, and an enclosure wall connecting the top wall and the bottom wall and enclosing the cavity. The limiting structure is connected to the enclosure wall. The top wall is closer to the diaphragm relative to a top of the limiting structure. A bottom of the limiting structure is closer to the diaphragm relative to the bottom wall.

As an improvement, the substrate and the limiting structure are integrally formed.

In the MEMS microphone according to the present disclosure, the limiting structure in the cavity of the substrate can limit the maximum displacement of the diaphragm away from the backplate so as to make the displacement of the diaphragm away from the backplate not exceed the ultimate displacement that the material of the diaphragm can withstand, thus avoiding the diaphragm being damaged by the displacement of the diaphragm away from the backplate exceeding the ultimate displacement that the material of the diaphragm can withstand, and improving the reliability of the MEMS microphone. In addition, the maximum displacement of the diaphragm away from the backplate is not less than the normal working displacement of the diaphragm away from the backplate, thus, the limiting structure does not affect the normal working of the MEMS microphone.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is a cross-sectional view of a first MEMS microphone of the present disclosure.

FIG. 2 is a cross-sectional view of an assembly of a substrate and a limiting structure of the first MEMS microphone of the present disclosure.

FIG. 3 is an isometric view of the assembly of the substrate and the limiting structure of the first MEMS microphone of the present disclosure.

FIG. 4 is an isometric view of an assembly of a substrate and a limiting structure of a second MEMS microphone of the present disclosure.

FIG. 5 is an isometric view of an assembly of a substrate and a limiting structure of a third MEMS microphone of the present disclosure.

FIG. 6 is a cross-sectional view of an assembly of a substrate and a limiting structure of a fourth MEMS microphone of the present disclosure.

FIG. 7 is a cross-sectional view of an assembly of a substrate and a limiting structure of a fifth MEMS microphone of the present disclosure.

FIG. 8 is a cross-sectional view of an assembly of a substrate and a limiting structure of a sixth MEMS microphone of the present disclosure.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

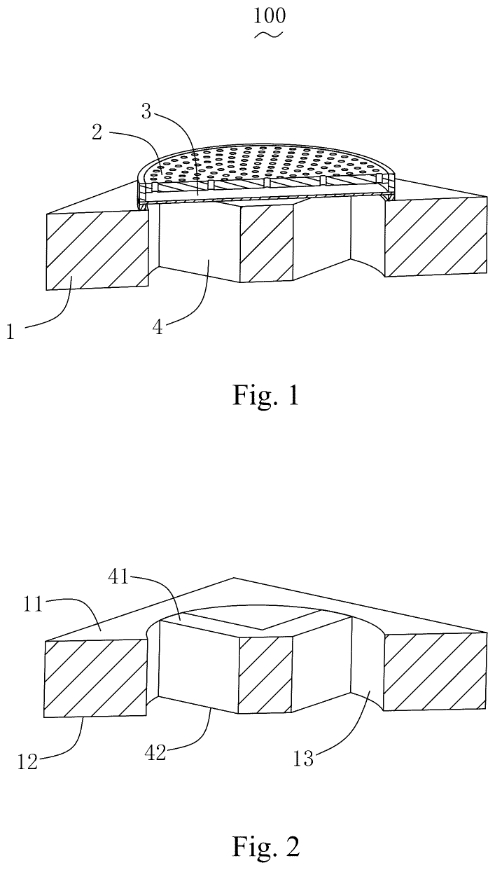

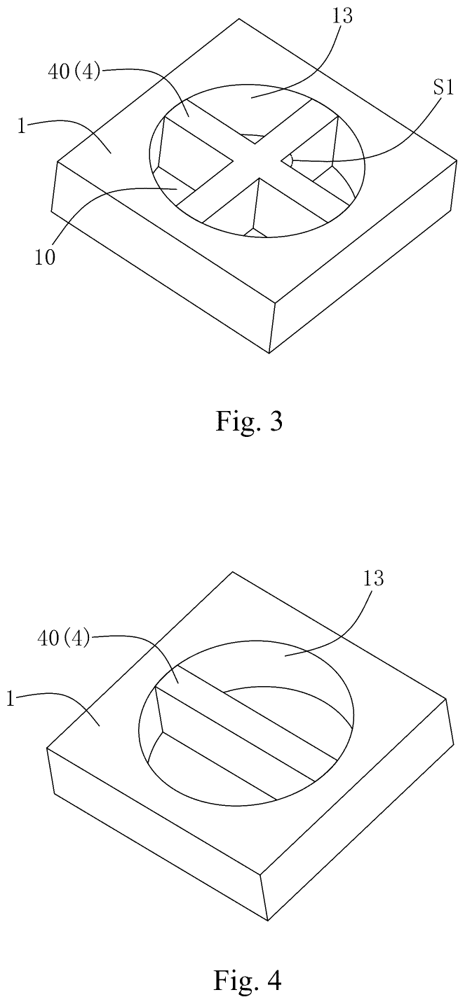

Referring to FIGS. 1-3, the present disclosure discloses a MEMS microphone 100 including a substrate 1 with a cavity 10, a backplate 2 disposed above the substrate 1, and a diaphragm 3 disposed between the backplate 2 and the substrate 1.

The substrate 1 includes a top wall 11, a bottom wall 12 opposite to the top wall 11, and an enclosure wall 13 connecting the top wall 11 and the bottom wall 12 and enclosing the cavity 10.

The MEMS microphone 100 further includes a limiting structure 4 disposed in the cavity 10 for limiting a maximum displacement of the diaphragm 3 away from the backplate 2 that is not less than a normal working displacement of the diaphragm 3 away from the backplate 2.

In this embodiment, the limiting structure 4 is connected to the enclosure wall 13. Optionally, in other embodiments, the limiting structure 4 is not limited to being connected to the enclosure wall 13, as long as any form in which the limiting structure 4 can be formed in the cavity 10 is feasible.

In this embodiment, the limiting structure 4 is formed by two connecting walls 40 connected to the enclosure wall 13 and intersecting each other. As a choice, the two connecting walls 40 intersect and form four intersection intervals S1, and each intersection interval S1 is an angle of 90 degrees.

In this embodiment, the limiting structure 4 includes a top 41 and a bottom 42 opposite to the top 41. The top wall 11 is arranged flush with the top 41 of the limiting structure 4. The bottom wall 12 is arranged flush with the bottom 42 of the limiting structure 4.

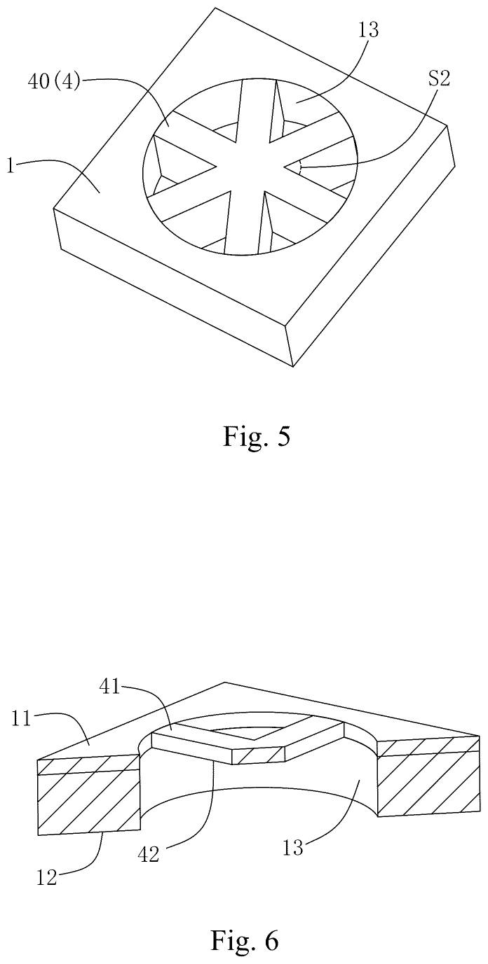

In some embodiments, as shown in FIG. 4, the limiting structure 4 can also be formed by a single connecting wall 40 connected to the enclosure wall 13. In some embodiments, as shown in FIG. 5, the limiting structure 4 can also be formed by three connecting walls 40 connected to the enclosure wall 13 and intersecting each other. As a choice, the three connecting walls 40 intersect at one place and form six intersection intervals S2, and each intersection interval S2 is an angle of 60 degrees. Furtherly, the limiting structure 4 can also be formed by more than three connecting walls 40 connected to the enclosure wall 13 and intersecting each other. As a choice, the more than three connecting walls 40 intersect at one place and form equal intersection intervals.

In some embodiments, as shown in FIG. 6, the limiting structure 4 is connected to the enclosure wall 13. The top wall 11 is arranged flush with the top 41 of the limiting structure 4. The bottom 42 of the limiting structure 4 is closer to the diaphragm 3 relative to the bottom wall 12.

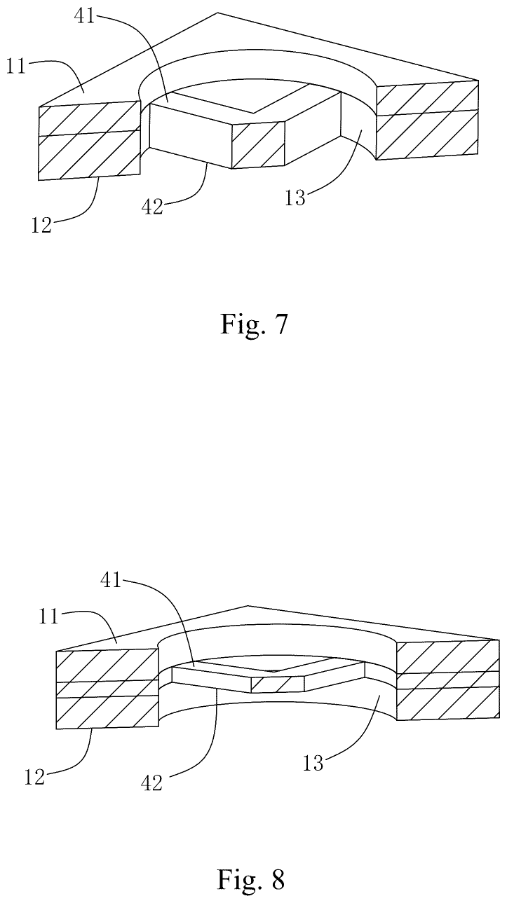

In some embodiments, as shown in FIG. 7, the limiting structure 4 is connected to the enclosure wall 13. The bottom wall 12 is arranged flush with the bottom 42 of the limiting structure 4. The top wall 11 is closer to the diaphragm 3 relative to the top 41 of the limiting structure 4. Appropriately increasing the distance between the diaphragm 3 and the limiting structure 4 can reduce the squeeze film damping formed by the limiting structure 4 on the diaphragm 3.

In some embodiments, as shown in FIG. 8, the limiting structure 4 is connected to the enclosure wall 13. The top wall 11 is closer to the diaphragm 3 relative to the top 41 of the limiting structure 4. The bottom 42 of the limiting structure 4 is closer to the diaphragm 3 relative to the bottom wall 12. Appropriately increasing the distance between the diaphragm 3 and the limiting structure 4 can reduce the squeeze film damping formed by the limiting structure 4 on the diaphragm 3.

As a choice, the substrate 1 and the limiting structure 4 can be integrally formed, the limiting structure 4 is formed together when the cavity 10 is formed, that is, the limiting structure 4 can be formed by a part of the material forming the substrate 1.

In the MEMS microphone according to the present disclosure, the limiting structure 4 in the cavity 10 of the substrate 1 can limit the maximum displacement of the diaphragm 3 away from the backplate 2 so as to make the displacement of the diaphragm 3 away from the backplate 2 not exceed the ultimate displacement that the material of the diaphragm 3 can withstand, thus avoiding the diaphragm 3 being damaged by the displacement of the diaphragm 3 away from the backplate 2 exceeding the ultimate displacement that the material of the diaphragm 3 can withstand, and improving the reliability of the MEMS microphone. In addition, the maximum displacement of the diaphragm 3 away from the backplate 2 is not less than the normal working displacement of the diaphragm 3 away from the backplate 2, thus, the limiting structure 4 does not affect the normal working of the MEMS microphone.

The above are only embodiments of the present disclosure. It should be pointed out that those of ordinary skill in the art may also make improvements without departing from the ideas of the present disclosure, all of which fall within the protection scope of the present disclosure.

What is claimed is:

1. A MEMS microphone, comprising:
a substrate with a cavity;
a backplate disposed above the substrate;
a diaphragm disposed between the backplate and the substrate; and
a limiting structure disposed in the cavity for limiting a maximum displacement of the diaphragm away from the backplate that is not less than a normal working displacement of the diaphragm away from the backplate.

2. The MEMS microphone as described in claim 1, wherein the substrate comprises a top wall, a bottom wall opposite to the top wall, and an enclosure wall connecting the top wall and the bottom wall and enclosing the cavity, the limiting structure is formed by a single connecting wall connected to the enclosure wall.

3. The MEMS microphone as described in claim 1, wherein the substrate comprises a top wall, a bottom wall opposite to the top wall, and an enclosure wall connecting the top wall and the bottom wall and enclosing the cavity, the limiting structure is formed by at least two connecting walls connected to the enclosure wall and intersecting each other.

4. The MEMS microphone as described in claim 3, wherein the at least two connecting walls intersect at one place and form equal intersection intervals.

5. The MEMS microphone as described in claim 1, wherein the substrate comprises a top wall, a bottom wall opposite to the top wall, and an enclosure wall connecting the top wall and the bottom wall and enclosing the cavity, the limiting structure is connected to the enclosure wall, the top wall is arranged flush with a top of the limiting structure, the bottom wall is arranged flush with a bottom of the limiting structure.

6. The MEMS microphone as described in claim 1, wherein the substrate comprises a top wall, a bottom wall opposite to the top wall, and an enclosure wall connecting the top wall and the bottom wall and enclosing the cavity, the limiting structure is connected to the enclosure wall, the top wall is arranged flush with a top of the limiting structure, a bottom of the limiting structure is closer to the diaphragm relative to the bottom wall.

7. The MEMS microphone as described in claim 1, wherein the substrate comprises a top wall, a bottom wall opposite to the top wall, and an enclosure wall connecting the top wall and the bottom wall and enclosing the cavity, the limiting structure is connected to the enclosure wall, the bottom wall is arranged flush with a bottom of the limiting structure, the top wall is closer to the diaphragm relative to a top of the limiting structure.

8. The MEMS microphone as described in claim 1, wherein the substrate comprises a top wall, a bottom wall opposite to the top wall, and an enclosure wall connecting the top wall and the bottom wall and enclosing the cavity, the limiting structure is connected to the enclosure wall, the top wall is closer to the diaphragm relative to a top of the limiting structure, a bottom of the limiting structure is closer to the diaphragm relative to the bottom wall.

9. The MEMS microphone as described in claim 1, wherein the substrate and the limiting structure are integrally formed.
